(19) United States
(12) Patent Application Publication
(10) Pub. No.: US 2025/0121385 A1
(43) Pub. Date: Apr. 17, 2025

(54) RAIN SHOWER HEAD

(71) Applicant: Man Hon LEE, Kowloon (HK)

(72) Inventor: Man Hon LEE, Kowloon (HK)

(21) Appl. No.: 18/379,665

(22) Filed: Oct. 13, 2023

(51) Int. Cl. B05B 1/18; B05B 1/16

(52) U.S. Cl. CPC B05B 1/185; B05B 1/16

(57) ABSTRACT

A rain shower head including a first water outlet mechanism and a second water outlet mechanism. The first water outlet mechanism includes a water storage tank, a first water inlet pipe, a water inlet valve, a water discharge valve, and a control assembly. The second water outlet mechanism includes a second water outlet cavity and a second water inlet pipe. The first through holes of the first water outlet cavity of the first water outlet mechanism each has a cross-sectional area much greater than that of the second through holes of the second water outlet cavity of the second water outlet mechanism. The rain shower head features simple structure and convenience to use, and can achieve the basic showering function of a shower head and an instant large-water-volume showering experience, meeting the pursuit of young consumers for excitement.

### BACKGROUND OF THE INVENTION

The present invention relates to the technical field of shower heads and particularly pertains to a rain shower head.

At present, shower heads sold in the market vary in styles, textures and types. With the improvement of living standards, consumer demands have become increasingly diversified. To meet the demands of the consumers, existing rain shower heads are being equipped with various additional functions.

For example, Chinese Patent No. CN211678297U discloses a multifunctional rain shower head which comprises a mounting plate. The bottom of the mounting plate is connected with a water spraying plate through a first movable block and an adjusting driving member. The top of the water spraying plate is in communication with a communicating pipe through a first water inlet pipe, a second water inlet pipe and a third water inlet pipe. The lower surface of the water spraying plate is provided with a waterfall water outlet, an atomized water nozzle and a rainfall water outlet. The bottoms of the first water inlet pipe, the second water inlet pipe and the third water inlet pipe are in communication with the waterfall water outlet, the atomized water nozzle and the rainfall water outlet, respectively. The shower head has diversified functions by providing the waterfall water outlet, the atomized water nozzle and the rainfall water outlet.

However, young people may tend to seek excitement, and the aforementioned multifunctional rain shower head fails to meet the pursuit of the young people for thrilling experiences.

### BRIEF SUMMARY OF THE INVENTION

In order to overcome the shortcomings in the prior art, an object of the present invention is to provide a rain shower head featuring convenience to use and diversified functions, so as to meet the pursuit of young people for excitement.

To attain this, the rain shower head of the present invention comprises a first water outlet mechanism and a second water outlet mechanism; the first water outlet mechanism comprises a water storage tank, a first water inlet pipe, a water inlet valve, a water discharge valve and a control assembly; the first water inlet pipe is in communication with the water storage tank through the water inlet valve; a first water outlet cavity is disposed at a bottom of the water storage tank; the water storage tank is in communication with the first water outlet cavity through the water discharge valve; a plurality of first through holes are disposed at a bottom of the first water outlet cavity; the control assembly is in controlling connection with the water discharge valve; the second water outlet mechanism comprises a second water outlet cavity and a second water inlet pipe; the second water inlet pipe is in communication with the second water outlet cavity; a plurality of second through holes are disposed at a bottom of the second water outlet cavity; the first through holes each has a cross-sectional area much greater than that of each of the second through holes.

Furthermore, the rain shower head further comprises a water diverter; the first water inlet pipe and the second water inlet pipe are in communication with a water source through the water diverter; the water diverter is configured to selectively allow or block water flow from the water source to the first water inlet pipe and/or the second water inlet pipe; the water diverter has four operating positions; the four operating positions respectively correspond to: (1) allowing water flow to the first water inlet pipe and blocking water flow to the second water inlet pipe, (2) allowing water flow to the second water inlet pipe and blocking water flow to the first water inlet pipe, (3) allowing simultaneous water flow to the first water inlet pipe and the second water inlet pipe, and (4) simultaneously blocking water flow to the first water inlet pipe and the second water inlet pipe.

Furthermore, the second water outlet cavity is disposed at the bottom of the water storage tank, and the second water outlet cavity is arranged to surround an outer side wall of the first water outlet cavity.

Furthermore, both the water inlet valve and the water discharge valve are arranged inside the water storage tank.

Furthermore, the water inlet valve comprises a water inlet valve body, a floating block control assembly and a water stopper; a first water inlet, a first water outlet and a conduction channel are disposed in the water inlet valve body; the first water inlet is in communication with the first water outlet through the conduction channel; the first water inlet is in communication with the first water inlet pipe; the first water outlet is in communication with an interior of the water storage tank; the water stopper is disposed in the conduction channel; the floating block control assembly is connected with the water stopper, and drives the water stopper to move so as to open or close the conduction channel.

Furthermore, the conduction channel comprises a transverse channel and a vertical channel; a first water flow-through opening is arranged between the transverse channel and the vertical channel; the vertical channel is in communication with the transverse channel through the first water flow-through opening; the first water inlet is formed in the transverse channel; the first water outlet is formed in the vertical channel; the water stopper is arranged in the transverse channel; the floating block control assembly drives the water stopper to move so as to open or close the first water flow-through opening.

Furthermore, the floating block control assembly comprises a connecting rod, an adjusting rod and a floating block; a first end of the connecting rod penetrates through a side wall of the water inlet valve body to connect with the water stopper, and a second end of the connecting rod is connected with an upper end of the adjusting rod; a lower end of the adjusting rod is fixedly connected with the floating block, and the floating block movably sleeves the water inlet valve body.

Furthermore, the water discharge valve comprises a water discharge valve body and a discharge button; a second water inlet and a second water outlet are formed in the water discharge valve body; the second water inlet is in communication with the interior of the water storage tank; the second water outlet is in communication with the first water outlet cavity; a second water flow-through opening is further formed in the water discharge valve body; the second water inlet is in communication with the second water outlet through the second water flow-through opening; the discharge button is arranged at a top end of the water discharge valve body, and extends downwards to form a stopper for opening or closing the second water flow-through opening; the control assembly is in controlling connection with the discharge button.

Furthermore, the control assembly comprises a switch and an electronic control valve; the switch is in controlling connection with the electronic control valve; the electronic control valve is in driving connection with the discharge button.

Furthermore, a top of the water storage tank and/or a top of the second water outlet cavity are provided with a hanging connection assembly.

The present invention has the following beneficial effects: The rain shower head of the present invention features simple structure, convenience to use and multifunctionality, and can provide different experiences for users. The rain shower head is provided with a first water outlet mechanism and a second water outlet mechanism that are completely different in functionality. The second water outlet mechanism is a common shower head that meets the showering requirements of general consumers. Compared with the second water outlet mechanism, the first water outlet mechanism is additionally provided with the water storage tank which can store a large volume of water. When the control assembly controls the water discharge valve to discharge the water, the large volume of water in the water storage tank is quickly discharged downwards to the first water outlet cavity through the water discharge valve and rapidly rinses the user through the plurality of first through holes with greater cross-sectional areas in the first water outlet cavity, which produces a strong impact feeling due to instant rinsing with the large volume of water, providing the user with a novel and thrilling experience as if a bucket of water is poured down, and meeting the pursuit of young consumers for excitement.

### BRIEF DESCRIPTION OF THE DRAWINGS

FIG. 1 is a schematic view of the three-dimensional structure of the rain shower head;

FIG. 2 is a bottom view of the rain shower head;

FIG. 3 is a schematic view showing the connection of the first water inlet pipe, the second water inlet pipe, the water diverter and the water source.

FIG. 4 is a sectional view of the rain shower head;

FIG. 5 is a schematic view of the three-dimensional structure of the water inlet valve;

FIG. 6 is a sectional view of the water inlet valve during water inflow;

FIG. 7 is a partial enlarged view of the portion A of FIG. 6;

FIG. 8 is a schematic view of the three-dimensional structure of the water discharge valve; and

FIG. 9 is a partial sectional view of the water discharge valve.

The reference numerals include:
11, water storage tank; 12, first water inlet pipe; 13, water inlet valve; 131, water inlet valve body; 1311, first water outlet; 1312, transverse channel; 1313, first water inlet; 1314, vertical channel; 1315, first water flow-through opening; 1316, side wall; 132, water stopper; 133, connecting rod; 134, adjusting rod; 135, floating block; 14, water discharge valve; 141, water discharge valve body; 1411, second water inlet; 1412, second water outlet; 1413, second water flow-through opening; 142, discharge button; 143, stopper; 15, first water outlet cavity; 151, first through hole; 152, outer side wall; 21, second water outlet cavity; 211, second through hole; 22, second water inlet pipe; 3, control assembly; 31, switch; 32, electronic control valve; 5, hanging connection assembly; 51, first connecting piece; 52, second connecting piece; 6, conduction channel; 7, floating block control assembly; 8, water diverter; 9, water source.

### DETAILED DESCRIPTION OF THE INVENTION

In order to facilitate the understanding of those skilled in the art, the present invention is further described below with reference to the embodiments and the accompanying drawings, and the content of the detailed description is not intended to limit the present invention.

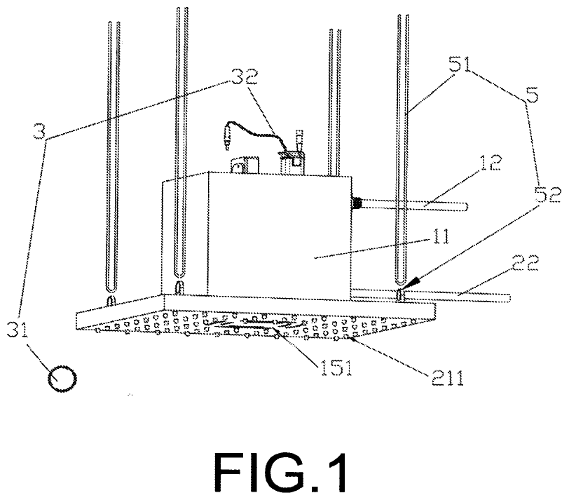

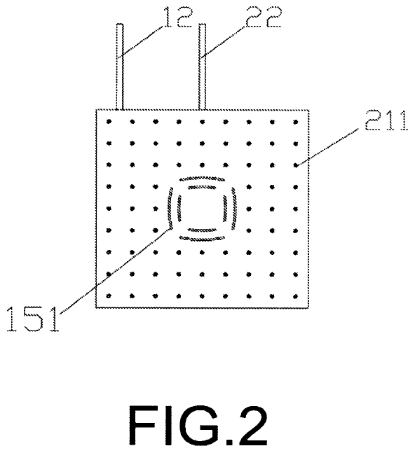

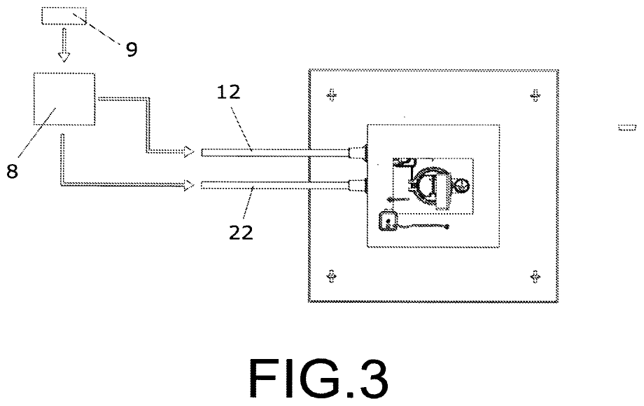

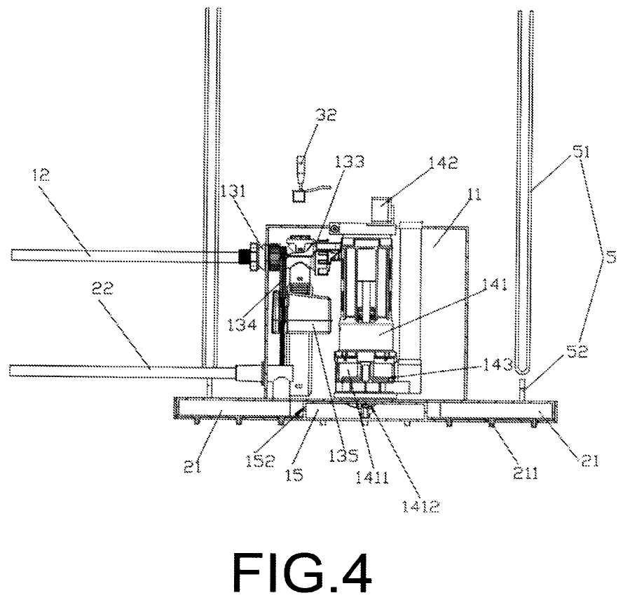

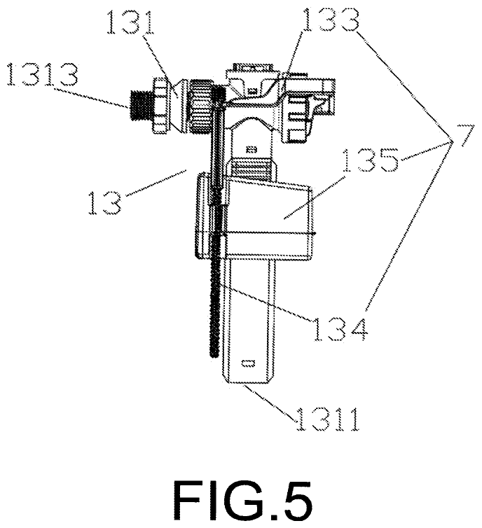

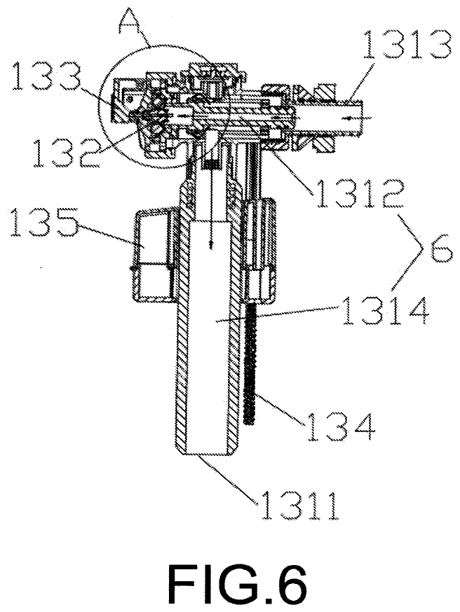

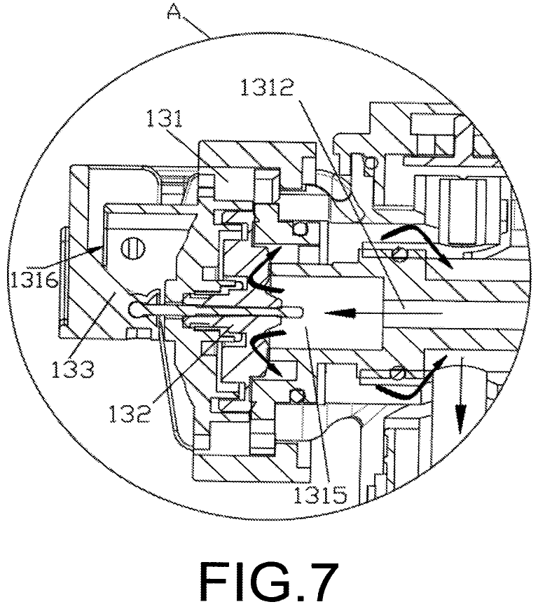

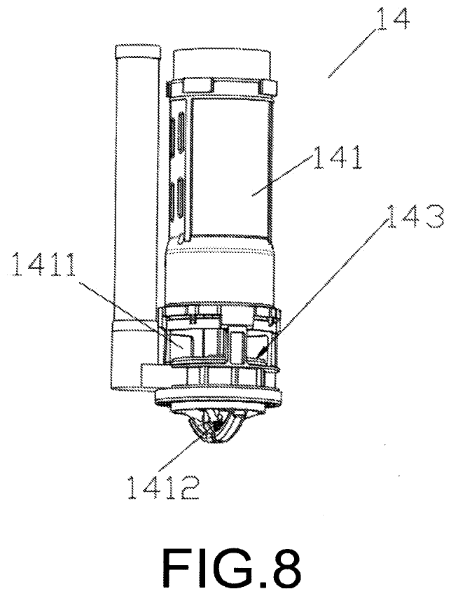

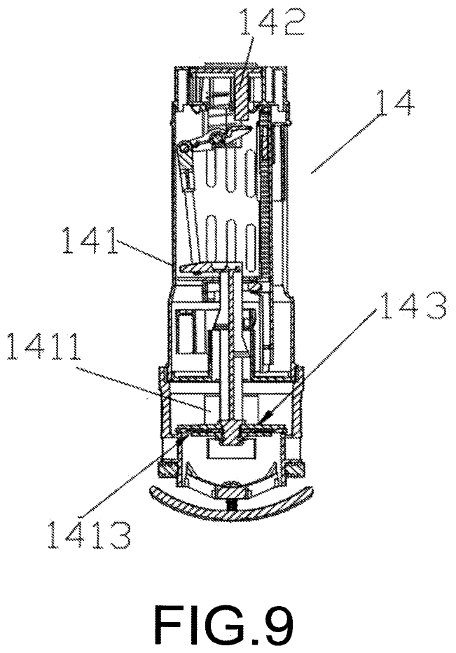

As shown in FIGS. 1-9, the rain shower head comprises a first water outlet mechanism and a second water outlet mechanism. The first water outlet mechanism comprises a water storage tank 11, a first water inlet pipe 12, a water inlet valve 13, a water discharge valve 14 and a control assembly 3. The first water inlet pipe 12 is in communication with the water storage tank 11 through the water inlet valve 13. A first water outlet cavity 15 is disposed at a bottom of the water storage tank 11. The water storage tank 11 is in communication with the first water outlet cavity 15 through the water discharge valve 14. A plurality of first through holes 151 are disposed at a bottom of the first water outlet cavity 15. The control assembly 3 is in controlling connection with the water discharge valve 14. The second water outlet mechanism comprises a second water outlet cavity 21 and a second water inlet pipe 22. The second water inlet pipe 22 is in communication with the second water outlet cavity 21. A plurality of second through holes 211 are disposed at a bottom of the second water outlet cavity 21. The first through holes 151 each has a cross-sectional area much greater than that of each of the second through holes 211.

The rain shower head of the present invention features simple structure, convenience to use, and multiple showering functionality, and can provide different experiences for users. The rain shower head is provided with a first water outlet mechanism and a second water outlet mechanism that are completely different in functionality. The second water outlet mechanism is a common shower head that meets the showering requirements of general consumers. Compared with the second water outlet mechanism, the first water outlet mechanism is additionally provided with the water storage tank 11 which can store a large volume of water. When the control assembly 3 controls the water discharge valve 14 to discharge the water, the large volume of water in the water storage tank 11 is quickly discharged downwards to the first water outlet cavity 15 through the water discharge valve 14 and rapidly rinses the user through the plurality of first through holes 151 with greater cross-sectional areas in the first water outlet cavity 15, which produces a strong impact feeling due to instant rinsing with the large volume of water, providing the user with a novel and thrilling experience as if a bucket of water is poured down, and meeting the pursuit of young consumers for excitement.

In this embodiment, for example, the capacity of the water storage tank 11 is configured to be 3 L to 35 L, such that a large volume of water can be stored in the water storage tank 11. The cross-sectional area of each of the first through holes 151 is configured to be 5 to 30 times greater than that of each of the second through holes 211, such that when the water storage tank 11 is discharged through the water discharge valve 14, the large volume of water is quickly drained downwards through the first through holes 151, thereby achieving the effect of an instant high water flow rinsing the user, so as to generate a strong sensation of impact and provide the user with a thrilling experience.

Furthermore, the rain shower head further comprises a water diverter 8. The first water inlet pipe 12 and the second water inlet pipe 22 are in communication with a water source 9 through the water diverter 8. The water diverter 8 is configured to selectively allow or block water flow from the water source 9 to the first water inlet pipe 12 and/or the second water inlet pipe 22. In other words, the diverter 8 may selectively allow water flow to either one of the first water inlet pipe 12 or the second water inlet pipe 22, allow simultaneous water flow to both the first water inlet pipe 12 and the second water inlet pipe 22, or simultaneously block water flow to both the first water inlet pipe 12 and the second water inlet pipe 22, thereby controlling water flow to the first water inlet pipe 12 and the second water inlet pipe 22.

In this embodiment, the water diverter 8 has four operating positions. The four operating positions respectively correspond to: (1) allowing water flow to the first water inlet pipe 12 and blocking water flow to the second water inlet pipe 22, (2) allowing water flow to the second water inlet pipe 22 and blocking water flow to the first water inlet pipe 12, (3) allowing simultaneous water flow to the first water inlet pipe 12 and the second water inlet pipe 22, and (4) simultaneously blocking water flow to the first water inlet pipe 12 and the second water inlet pipe 22. Specifically, when the operating position of the water diverter 8 is adjusted to the operating position corresponding to water flow to the first water inlet pipe 12, water enters the water storage tank 11 through the first water inlet pipe 12 and the water inlet valve 13 for storage, and when the water volume in the water storage tank 11 reaches a certain volume, the user can operate the control assembly 3 to instantly and quickly discharge the water in the water storage tank 11 downwards. When the operating position of the water diverter 8 is adjusted to the operating position corresponding to water flow to the second water inlet pipe 22, water enters the second water outlet cavity 21 through the second water inlet pipe 22 and is sprayed downwards through the second through holes 211, thereby achieving normal shower head spraying functionality. When the operating position of the water diverter 8 is adjusted to the operating position corresponding to simultaneous water flow to the first water inlet pipe 12 and the second water inlet pipe 22, the rain shower head can achieve both the normal shower head spraying functionality and storage of the water in the water storage tank 11, thereby achieving the function of instant large-water-volume showering. When the operating position of the water diverter 8 is adjusted to the operating position corresponding to simultaneous blocking of water flow to the first water inlet pipe 12 and the second water inlet pipe 22, the normal shower head spraying functionality is closed, and water does not enter the water storage tank 11 either. The water diverter 8 features easy operation and high functionality.

Furthermore, the second water outlet cavity 21 is also disposed at the bottom of the water storage tank 11, and arranged to surround an outer side wall 152 of the first water outlet cavity 15, thereby forming a compact structure which is beneficial to achieving the effects of normal showering and rinsing at the same time, thus improving the experience of the user.

Furthermore, the water inlet valve 13 is arranged inside the water storage tank 11, and comprises a water inlet valve body 131, a floating block control assembly 7 and a water stopper 132. A first water inlet 1313, a first water outlet 1311, and a conduction channel 6 are disposed in the water inlet valve body 131. The first water inlet 1313 is in communication with the first water outlet 1311 through the conduction channel 6. The first water inlet 1313 is in communication with the first water inlet pipe 12. The first water outlet 1311 is in communication with an interior of the water storage tank 11. The water stopper 132 is disposed in the conduction channel 6. The floating block control assembly 7 is connected with the water stopper 132, and drives the water stopper 132 to move so as to open or close the conduction channel 6. In this embodiment, by arranging the water inlet valve 13 inside the water storage tank 11, the floating block control assembly 7 can conveniently move up and down according to water level changes in the water storage tank 11, so as to control the water stopper 132 to move to open or close the conduction channel 6, thereby automatically controlling water inflow according to water level changes in the water storage tank 11, and ensuring that an appropriate water volume is kept within the water storage tank 11.

Furthermore, the conduction channel 6 comprises a transverse channel 1312 and a vertical channel 1314. A first water flow-through opening 1315 is arranged between the transverse channel 1312 and the vertical channel 1314. The vertical channel 1314 is in communication with the transverse channel 1312 through the first water flow-through opening 1315. The first water inlet 1313 is formed in the transverse channel 1312. The first water outlet 1311 is formed in the vertical channel 1314. The water stopper 132 is arranged in the transverse channel 1312. The floating block control assembly 7 drives the water stopper 132 to move in the transverse channel 1312 so as to open or close the first water flow-through opening 1315. In this embodiment, specifically, the first water inlet 1313 is formed at a first end of the transverse channel 1312. The water stopper 132 and the first water flow-through opening 1315 are both located at a second end of the transverse channel distal from the first water inlet 1313. The vertical channel 1314 is connected with a middle portion of the transverse channel 1312. By reasonably arranging the conduction channel 6 of the water inlet valve 13, the first water flow-through opening 1315 can be controlled to be open or closed by the movement of the water stopper 132.

Furthermore, the floating block control assembly 7 comprises a connecting rod 133, an adjusting rod 134, and a floating block 135. A first end of the connecting rod 133 penetrates through a side wall 1316 of the water inlet valve body 131 to connect with the water stopper 132, and a second end of the connecting rod 133 is connected with an upper end of the adjusting rod 134. A lower end of the adjusting rod 134 is fixedly connected with the floating block 135, and the floating block 135 movably sleeves the water inlet valve body 131. In this embodiment, the floating block 135 movably sleeves the water inlet valve body 131, thereby allowing the floating block 135 to move up and down along the water inlet valve body 131 according to the water level changes in the water storage tank 11. Preferably, the adjusting rod 134 is in threaded connection with the floating block 135, such that the user can conveniently adjust a relative position between the adjusting rod 134 and the floating block 135 according to the demand for the instant showering water quantity, thereby controlling the maximum water storage capacity in the water storage tank 11. Specifically, when the water level of the water storage tank 11 decreases, the floating block 135 descends to drive the adjusting rod 134 to descend, and the second end of the connecting rod 133 which is proximal to the adjusting rod 134 also descends, such that the water stopper 132 is pulled by the connecting rod 133 and gradually moves away from the first water flow-through opening 1315 until the first water flow-through opening 1315 is open, so that the first water inlet 1313 is in communication with the first water outlet 1311, and thereby achieving the purpose of water filling in the water storage tank 11. When the water level of the water storage tank 11 rises, the floating block 135 drives the adjusting rod 134 to ascend, and the second end of the connecting rod 133 which is proximal to the adjusting rod 134 also ascends, such that the water stopper 132 is pushed by the connecting rod 133 and gradually approaches the first water flow-through opening 1315 until the first water flow-through opening 1315 is covered, so that the first water inlet 1313 is not in communication with the first water outlet 1311, thereby achieving the purpose of stopping water filling in the water storage tank 11. Through the arrangement of the floating block control assembly 7, the functionality that the water inlet valve 13 automatically controls water inflow according to the water level in the water storage tank 11 can be achieved.

Furthermore, the water discharge valve 14 is also arranged inside the water storage tank 11, and comprises a water discharge valve body 141 and a discharge button 142. A second water inlet 1411 and a second water outlet 1412 are formed in the water discharge valve body 141. The second water inlet 1411 is in communication with the interior of the water storage tank 11. The second water outlet 1412 is in communication with the first water outlet cavity 15. A second water flow-through opening 1413 is further formed in the water discharge valve body 141. The second water inlet 1411 is in communication with the second water outlet 1412 through the second water flow-through opening 1413. The discharge button 142 is arranged at a top end of the water discharge valve body 141, and extends downwards to form a stopper 143 for opening or closing the second water flow-through opening 1413. The control assembly 3 is in controlling connection with the discharge button 142.

Specifically, when the instant large-water-volume showering function of the rain shower head needs to be activated, the user operates the control assembly 3. The control assembly 3 drives the discharge button 142 to drive the stopper 143 to move upwards along an inner wall of the water discharge valve body 141, such that the second water flow-through opening 1413 opens, and the second water inlet 1411 is in communication with the second water outlet 1412. The water in the water storage tank 11 enters the water discharge valve body 141 through the second water inlet 1411, and then quickly enters the first water outlet cavity 15 through the second water outlet 1412, thereby achieving the function of quickly discharging the water in the water storage tank 11 by the water discharge valve 14. Finally, a large volume of water flows out instantaneously through the first through holes 151 with a greater cross-sectional area, and thus the instant large-water-volume showering effect is achieved.

Furthermore, the control assembly 3 comprises a switch 31 and an electronic control valve 32. The switch 31 is in controlling connection with the electronic control valve 32. The electronic control valve 32 is in driving connection with the discharge button 142. In this embodiment, the electronic control valve 32 is installed on the water storage tank 11 so as to be in drive connection with the discharge button 142. The switch 31 may be installed at a position easily accessible for the user to touch, such as the wall of the bathroom. When the user touches the switch 31, the electronic control valve 32 is activated and drives the discharge button 142, such that the instant large-water-volume showering function can be activated, featuring ease to use.

Furthermore, a top of the water storage tank 11 and/or a top of the second water outlet cavity 21 are provided with a hanging connection assembly 5. In this embodiment, the top of the second water outlet cavity 21 is provided with the hanging connection assembly 5. The hanging connection assembly 5 comprises a number of first connecting pieces 51 and an equal number of second connecting pieces 52. The second connecting pieces 52 are distributed in form of a rectangle at a top end of the second water outlet cavity 21. The first connecting pieces 51 are in one-to-one correspondence with the second connecting pieces 52, and a lower end of each of the first connecting pieces 51 is connected with the corresponding second connecting piece 52. An upper end of each of the first connecting pieces 51 is connected with a fixed object, such as the roof of the bathroom. Preferably, the first connecting piece 51 is detachably connected with the second connecting piece 52. The first connecting piece 51 is a thicker steel wire. The second connecting piece 52 extends upwards from the top end of the second water outlet cavity 21, and is provided with a through hole. A first end of the steel wire is connected with the fixed object, and a second end of the steel wire penetrates through the through hole and is connected with the fixed object. Since the water storage tank 11 stores a large volume of water, the whole rain shower head may have a larger weight, and the rain shower head can be stably hung by means of the aforementioned method.

Those above are merely preferred embodiments of the present invention. For those of ordinary skills in the art, changes may be made in specific implementations and scope of application based on the spirits of the present invention, and the contents of this specification should not be construed as limiting the present invention.

What is claimed is:

1. A rain shower head, characterized in that it comprises a water storage tank, a first water inlet pipe, a water inlet valve, a water discharge valve, a control assembly, a second water outlet cavity and a second water inlet pipe; the first water inlet pipe is in communication with the water storage tank through the water inlet valve; a first water outlet cavity is disposed at a bottom of the water storage tank; the water storage tank is in communication with the first water outlet cavity through the water discharge valve; a plurality of first through holes are disposed at a bottom of the first water outlet cavity; the control assembly is in controlling connection with the water discharge valve; the second water inlet pipe is in communication with the second water outlet cavity; a plurality of second through holes are disposed at a bottom of the second water outlet cavity; the first through holes each has a cross-sectional area much greater than that of each of the second through holes.

2. The rain shower head as in claim 1, characterized in that it further comprises a water diverter; the first water inlet pipe and the second water inlet pipe are in communication with a water source through the water diverter; the water diverter is configured to selectively allow or block water flow from the water source to the first water inlet pipe and/or the second water inlet pipe.

3. The rain shower head as in claim 1, characterized in that the second water outlet cavity is disposed at the bottom of the water storage tank, and the second water outlet cavity is arranged to surround an outer side wall of the first water outlet cavity.

4. The rain shower head as in claim 1, characterized in that both the water inlet valve and the water discharge valve are arranged inside the water storage tank.

5. The rain shower head as in claim 4, characterized in that the water inlet valve comprises a water inlet valve body, a floating block control assembly and a water stopper; a first water inlet, a first water outlet and a conduction channel are disposed in the water inlet valve body; the first water inlet is in communication with the first water outlet through the conduction channel; the first water inlet is in communication with the first water inlet pipe; the first water outlet is in communication with an interior of the water storage tank; the water stopper is disposed in the conduction channel; the floating block control assembly is connected with the water stopper, and drives the water stopper to move so as to open or close the conduction channel.

6. The rain shower head as in claim 5, characterized in that the conduction channel comprises a transverse channel and a vertical channel; a first water flow-through opening is arranged between the transverse channel and the vertical channel; the vertical channel is in communication with the transverse channel through the first water flow-through opening; the first water inlet is formed in the transverse channel; the first water outlet is formed in the vertical channel; the water stopper is arranged in the transverse channel; the floating block control assembly drives the water stopper to move so as to open or close the first water flow-through opening.

7. The rain shower head as in claim 5, characterized in that the floating block control assembly comprises a connecting rod, an adjusting rod, and a floating block; a first end of the connecting rod penetrates through a side wall of the water inlet valve body to connect with the water stopper, and a second end of the connecting rod is connected with an upper end of the adjusting rod; a lower end of the adjusting rod is fixedly connected with the floating block, and the floating block movably sleeves the water inlet valve body.

8. The rain shower head as in claim 4, characterized in that the water discharge valve comprises a water discharge valve body and a discharge button; a second water inlet and a second water outlet are formed in the water discharge valve body; the second water inlet is in communication with the interior of the water storage tank; the second water outlet is in communication with the first water outlet cavity; a second water flow-through opening is further formed in the water discharge valve body; the second water inlet is in communication with the second water outlet through the second water flow-through opening; the discharge button is arranged at a top end of the water discharge valve body, and extends downwards to form a stopper for opening or closing the second water flow-through opening; the control assembly is in controlling connection with the discharge button.

9. The rain shower head as in claim 8, characterized in that the control assembly comprises a switch and an electronic control valve; the switch is in controlling connection with the electronic control valve; the electronic control valve is in driving connection with the discharge button.

10. The rain shower head as in claim 1, characterized in that a top of the water storage tank and/or a top of the second water outlet cavity are provided with a hanging connection assembly.
